(19) United States
(12) Patent Application Publication
(10) Pub. No.: US 2024/0378531 A1
(43) Pub. Date: Nov. 14, 2024

(54) DATA MANAGEMENT TECHNIQUES FOR REDUCING ACCESS TIME AND STORAGE SPACE USED FOR SEMICONDUCTOR MANUFACTURING DATA

(71) Applicant: Tignis, Inc., Seattle, WA (US)

(72) Inventor: Adam Ashenfelter, Albany, OR (US)

(73) Assignee: Tignis, Inc., Seattle, WA (US)

(21) Appl. No.: 18/660,126

(22) Filed: May 9, 2024

Related U.S. Application Data
(60) Provisional application No. 63/502,022, filed on May 12, 2023.

(51) Int. Cl. G06Q 10/0633; G06Q 50/04

(52) U.S. Cl. CPC G06Q 10/0633; G06Q 50/04

(57) ABSTRACT

In some embodiments, a computer-implemented method for managing semiconductor manufacturing data is provided. A computing system receives an incoming data record generated by a semiconductor fabrication plant. The incoming data record includes at least one measured value and a set of context values. The computing system determines one or more context documents that represent the set of context values of the incoming data record. The computing system stores, in a data store, a decomposed fab process record that includes a representation of the at least one measured value and the one or more context documents.

### CROSS-REFERENCE(S) TO RELATED APPLICATION(S)

This application claims the benefit of Provisional Application No. 63/502,022, filed May 12, 2023, the entire disclosure of which is hereby incorporated by reference herein for all purposes.

### BACKGROUND

It is desirable to store traces generated by sensors of a semiconductor fabrication plant for later analysis. For example, a process engineer may want to look for correlations between metrology and traces for a particular combination of recipe, tool, module, and time range. As yet another example, a process engineer may want to visualize changes in traces over time for a particular combination of recipe, tool, module, station, sensor, and time range. As still another example, a process engineer may want to generate a representative “golden trace” from traces for a particular combination of recipe, module, sensor, and time range. However, to be useful for such tasks, relevant traces should be retrievable from storage interactively (e.g., in less than a second).

However, given that the number of sensors in a semiconductor fabrication plant increases rapidly with the throughput of the semiconductor fabrication plant, a high-volume semiconductor fabrication plant may generate on the order of billion traces per year. Traditional techniques for storing traces, such as in their original form on a file system or in cloud storage, or in a time-series database (e.g., TimeScaleDB, etc.), are incapable of providing query access to such large numbers of records at a speed that is useful to process engineers. Further, given the number and collective size of the generated traces, storing the traces in their original form can be impractical due to the amount of storage required to do so. What is desired are techniques that allow for the fast retrieval of traces relevant to various types of queries useful to process engineers, as well as techniques to allow for more efficient storage of traces.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method for managing semiconductor manufacturing data is provided. A computing system receives an incoming data record generated by a semiconductor fabrication plant. The incoming data record includes at least one measured value and a set of context values. The computing system determines one or more context documents that represent the set of context values of the incoming data record. The computing system stores, in a data store, a decomposed fab process record that includes a representation of the at least one measured value and the one or more context documents.

In some embodiments, a non-transitory computer-readable medium having computer-executable instructions stored thereon is provided. The instructions, in response to execution by one or more processors of a computing system, cause the computing system to perform actions for managing semiconductor manufacturing data, the actions comprising: receiving, by the computing system, an incoming data record generated by a semiconductor fabrication plant, wherein the incoming data record includes at least one measured value and a set of context values; determining, by the computing system, one or more context documents that represent the set of context values of the incoming data record; and storing, by the computing system in a data store, a decomposed fab process record that includes a representation of the at least one measured value and the one or more context documents.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram that illustrates a non-limiting example embodiment of a system according to various aspects of the present disclosure.

FIG. 2 is a schematic illustration of a fab process record used to store information received from the semiconductor fabrication plant.

FIG. 3A and FIG. 3B illustrate non-limiting examples of representations in JSON of a fab process record for a metrology value and trace data, respectively.

FIG. 4 is a schematic illustration of a decomposed fab process record used to store information received from the semiconductor fabrication plant according to various aspects of the present disclosure.

FIG. 5 illustrates a non-limiting example embodiment of a decomposed fab process record for a trace, according to various aspects of the present disclosure.

FIG. 6 is a block diagram that illustrates aspects of a non-limiting example embodiment of a fab record management computing system according to various aspects of the present disclosure.

FIG. 7A-FIG. 7B are flowchart that illustrates a non-limiting example embodiment of a method of efficient storage of fab process records according to various aspects of the present disclosure.

FIG. 8 is a flowchart that illustrates a non-limiting example embodiment of a subroutine for storing a trace record in a compressed form according to various aspects of the present disclosure.

FIG. 9 is a flowchart that illustrates a non-limiting example embodiment of a subroutine for storing a trace record having a compressed version of trace data, according to various aspects of the present disclosure.

### DETAILED DESCRIPTION

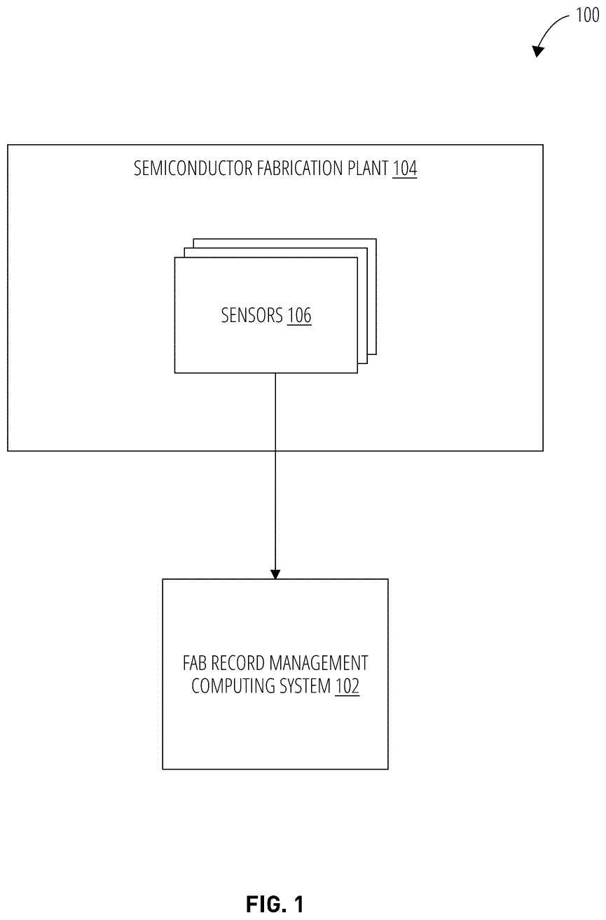

FIG. 1 is a block diagram that illustrates a non-limiting example embodiment of a system according to various aspects of the present disclosure. A semiconductor fabrication plant 104, or “fab,” includes a collection of tools that process silicon wafers. A tool may include one or more modules, and each module may include one or more stations. A station is a physical location where a wafer sits while undergoing a processing step of a semiconductor manufacturing process. Each station may have a set of sensors that are configured to generate data representing characteristics of the processing performed by the module (e.g., power, temperature, flow, pressure, etc.). For example, an inline coater/developer tool may include multiple coater modules. Each coater module station may include a solvent flow sensor and an exhaust pressure sensor. The inline coater/developer tool may also have multiple baking module stations, each having their own plate temperature sensor. For the sake of simplicity, FIG. 1 illustrates all of the sensors for all of the stations in the semiconductor fabrication plant 104 as sensors 106.

In a semiconductor manufacturing process, a recipe defines an overall process applied to a wafer as it proceeds through the modules of the semiconductor fabrication plant 104. As an example, a recipe may start with a processing step in a cooling module, followed by a step in a coating module, then a step in a baking module. The module-to-module flow defined by a recipe may include dozens or even hundreds of processing steps.

A trace is data collected by a sensor 106 of the semiconductor fabrication plant 104 while a wafer is being processed. Typically, a trace is a time series of values generated by the sensor 106, bounded by a start time and an end time of a process step. For example, a plate temperature trace may include a time series of values generated by a plate temperature sensor while a wafer was heating at a station in a bake module. Typically, the values of a trace will have a regular period (e.g., one value per second), though some traces may be aperiodic.

After completing the semiconductor manufacturing process, a sample of wafers are selected for detailed inspection and collection of metrology values. The metrology values (including but not limited to critical dimension) reflect the quality of the resulting wafer and are used for verifying the success of the overall semiconductor manufacturing process.

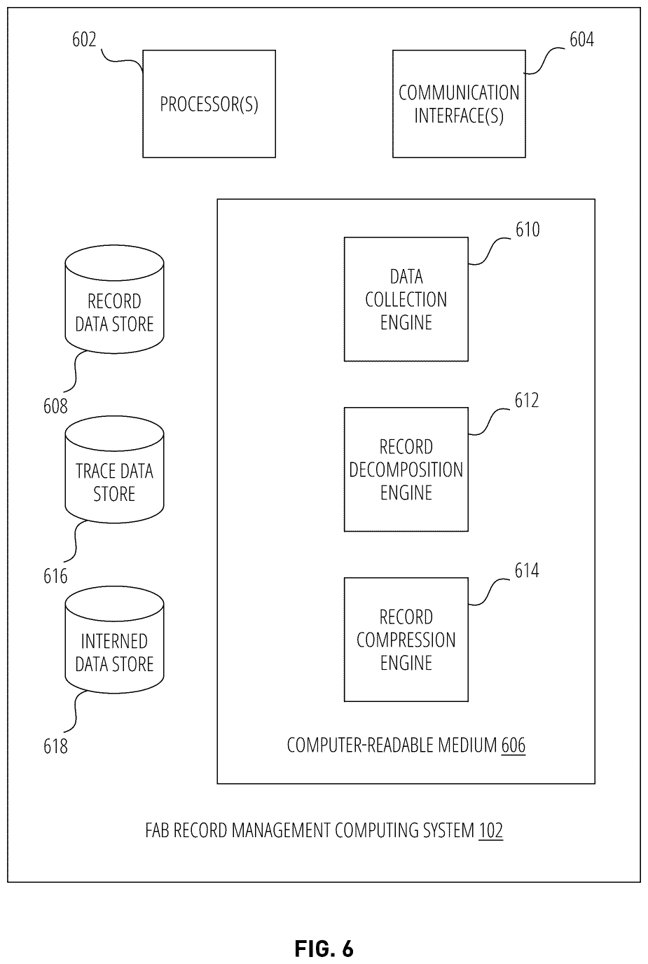

Once data is generated by the sensors 106 of the semiconductor fabrication plant 104, the data is transmitted to a fab record management computing system 102. Details of the configuration of the fab record management computing system 102 are illustrated in FIG. 6 and described in further detail below. One will recognize that while FIG. 1 illustrates a fab record management computing system 102 that receives information from a single semiconductor fabrication plant 104, in some embodiments, a single fab record management computing system 102 may receive information from more than one semiconductor fabrication plant 104, and may thus provide a shared platform for storage of data from multiple semiconductor fabrication plants 104 owned by the same or different entities.

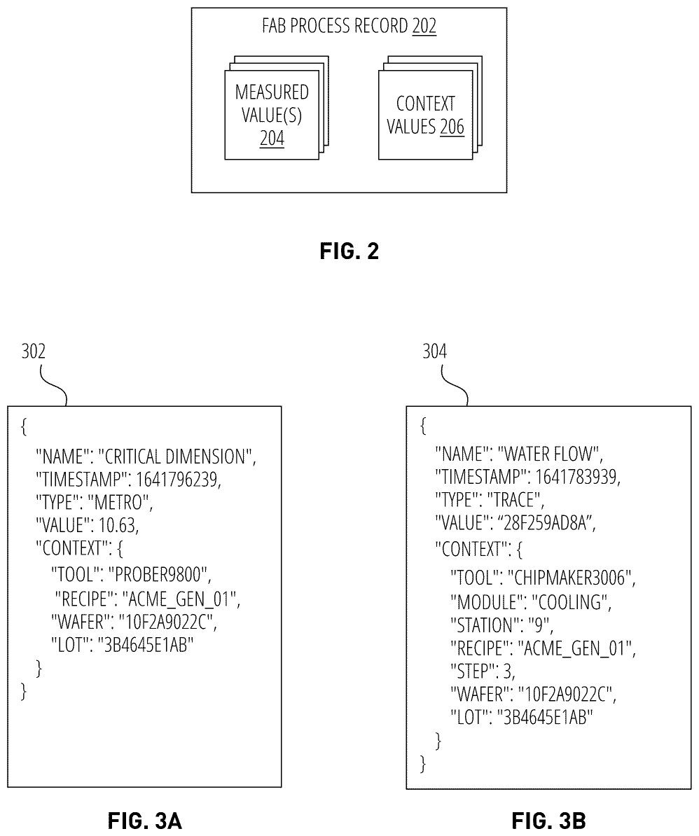

FIG. 2 is a schematic illustration of a fab process record used to store information received from the semiconductor fabrication plant 104. The fab process record 202 is an example of a naïve approach for storing information from the semiconductor fabrication plant 104 as may be done in traditional techniques. As shown, the fab process record 202 includes one or more measured values 204 and a set of context values 206. The one or more measured values 204 may be any type of information reported by the semiconductor fabrication plant 104, including but not limited to a single value reported by a metrology process or trace information generated by a sensor 106.

The set of context values 206 includes information describing the context in which the measured values 204 were collected, and typically includes information relevant to process engineers for grouping measured values 204 and/or querying for measured values 204 for comparison or other analysis. For example, the set of context values 206 may include information identifying a tool, module, and/or station associated with the measured values 204, attributes of a recipe being executed during generation of the measured values 204, attributes of an item being processed during generation of the measured values 204, and so on. The fab process record 202 may also include other metadata associated with the measured values 204, including but not limited to a type of the measured value 204 (e.g., trace or metrology), a name associated with the values being measured or a process being conducted, and/or a timestamp associated with the measured values 204.

The fab process record 202 may be presented and/or stored in any suitable format, including but not limited to structured formats such as JSON or XML. FIG. 3A and FIG. 3B illustrate non-limiting examples of representations in JSON of a fab process record for a metrology value and trace data, respectively. In FIG. 3A, a fab process record 202 for a metrology value is illustrated. In the metrology fab process record 302, a name field identifies the metrology value being measured, a timestamp field identifies a timestamp associated with the measurement, a type field identifies the metrology fab process record 302 as storing a single value representing a metrology measurement, and a value field includes the single value itself. The set of context values 206 are provided in a single group, and identify a tool used to collect the value, a recipe used to generate the measured wafer, an identifier of the measured wafer, and a lot number of the measured wafer.

In FIG. 3B a fab process record 202 for a trace is illustrated. In the trace fab process record 304, a name field identifies a type of the trace (e.g., a type of data being measured by the sensor 106), a timestamp field identifies a timestamp associated with the trace (e.g., a start time of the trace, or a timestamp at which the trace was reported to the fab record management computing system 102), and a type field identifies the trace fab process record 304 as storing a trace instead of a single value. The value field of the trace fab process record 304 stores a key that can be used to retrieve the trace from a trace data store. The trace data store may be a key-value store (e.g., Berkeley DB, GNU dbm, RocksDB, Amazon DynamoDB, Microsoft Azure Cosmos DB, etc.) that allows the large amount of data reported in the trace to be stored separately from the fab process record 202. The set of context values 206 are again provided in a single group, and identify a tool, a module, and a station being monitored by the sensor 106, a recipe and a step that were being executed while the trace was collected, and identifiers of the processed wafer and its lot number.

There are several traditional approaches used to store searchable records with structures such as the metrology fab process record 302 and the trace fab process record 304. Unfortunately, these traditional approaches have serious limitations for storing data produced by semiconductor fabrication plants 104 as discussed above. Traditional approaches for storing searchable data include using relational schemas and using document-oriented databases. When using a relational schema, the data to be stored would be normalized and indexed appropriately. When using a document-oriented database, the data would remain denormalized, and would be stored in a document-oriented database such as Amazon DocumentDB, Elasticsearch, MongoDB, or the like.

While a relational approach with appropriate indexing can provide efficient query performance, this approach is risky for the storage of data generated by semiconductor fabrication plants 104, particularly because the specifics of the generated data are not necessarily known beforehand. Every semiconductor fabrication plant 104 is different, and so providing a fab record management computing system 102 that may be used by multiple semiconductor fabrication plants 104 would be difficult since every semiconductor fabrication plant 104 would use its own customized schema. Even with a single semiconductor fabrication plant 104, the number of deployed sensors 106 makes it likely that reconfigurations or changes to the data provided by the semiconductor fabrication plant 104 will occur with some frequency, thus requiring changes to the schema and time-consuming data migrations. As such, while such approaches may be performant with regard to query response times, such rigidly structured techniques are not practical for processing data from semiconductor fabrication plants 104.

A schema-less, document-oriented approach uses less engineering overhead. However, one goal of the present disclosure is to be able to use the context values 206 to quickly infer inventory-style information (e.g., listing unique recipes) or quickly query based on the structure of the context (e.g., using distinct keys over all context values 206). Without normalized relational data, such queries become very computationally expensive, as many types of queries could require a scan over all of the data. While some document-oriented databases may support sharding over many machines to increase query speed, this is an expensive solution that is often impractical, and that can still struggle to achieve query speeds fast enough to provide an interactive user interface.

What is desired are data storage techniques that allow for both the high query speed offered by relational databases as well as the flexibility offered by document-oriented databases in order to meet the design goals of a system for managing data produced by a semiconductor fabrication plant 104.

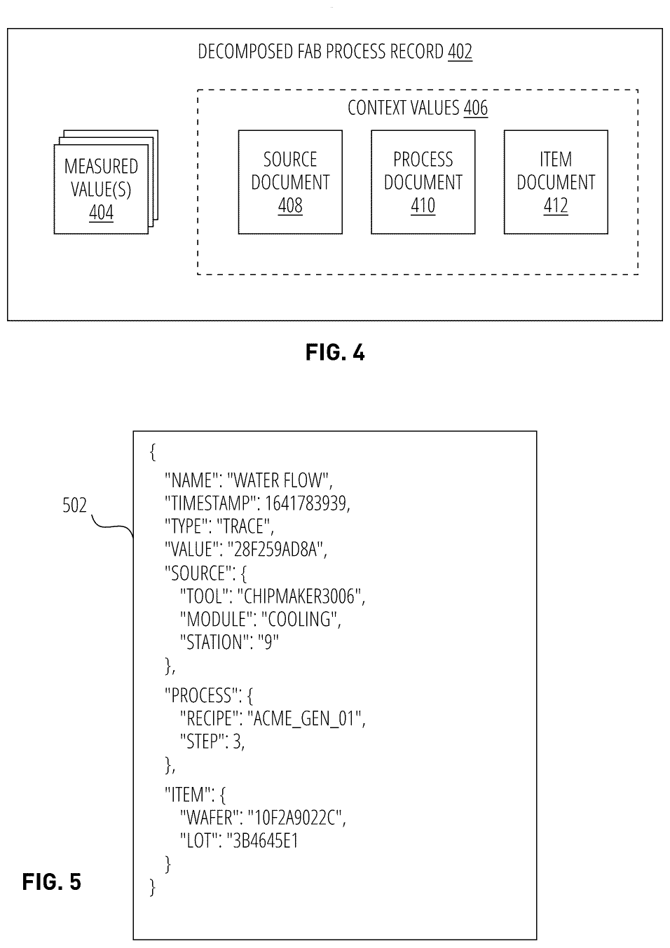

FIG. 4 is a schematic illustration of a decomposed fab process record used to store information received from the semiconductor fabrication plant 104 according to various aspects of the present disclosure. In some embodiments, a scheme such as the decomposed fab process record 402 is used to split the difference between the relational and document-oriented approaches described above, in order to maintain benefits of each approach while avoiding their separate drawbacks. To do so, the context values 406—which in the fab process record 202 were provided in a single group—are decomposed into three separate categories: source, process, and item. Each context value 406 is then stored in a source document 408, a process document 410, or an item document 412, depending on the type of value.

Context values 406 assigned to the source document 408 identify and/or describe the sensor 106 generating the measured values 404. Some non-limiting examples of context values 406 that may be assigned to the source document 408 include one or more of a tool ID, a module ID, a station ID, a sensor ID, a sensor description, or units in which the measured values 404 are reported.

Context values 406 assigned to the process document 410 identify and/or describe recipe-related information for what is happening to the wafer during the step being performed by the semiconductor fabrication plant 104 while the measured values 404 are being generated. Some non-limiting examples of context values 406 that may be assigned to the process document 410 include one or more of a recipe name or an identifier of a recipe step.

Context values 406 assigned to the item document 412 identify and/or describe information about the physical item (e.g., the wafer) being processed by the semiconductor fabrication plant 104 during generation of the measured values 404. Some non-limiting examples of context values 406 that may be assigned to the item document 412 include one or more of a wafer ID, a lot ID, or a FOUP (Front Opening Unified Pod) ID.

The context values 406 are decomposed into these concept-oriented documents to increase the chance that duplicate documents are encountered when storing the decomposed fab process record 402. It is clear that the decomposed context values 406 are likely to result in duplicates for multiple decomposed fab process records 402. For example, every measured value 404 associated with a given wafer while it is processed through the semiconductor fabrication plant 104 will be associated with duplicate item documents 412. Likewise, every time a given recipe step is executed can be associated with duplicate process documents 410, and every time a measured value 404 is reported from a given sensor, it can be associated with duplicate source documents 408. In a simple example where ten wafers are run through a ten-step manufacturing process, and where each step is monitored by five sensors, there would be 200 different documents needed to store the combinations of context values 206 when using the naïve approach of FIG. 2 (10 wafers, multiplied by 10 steps, multiplied by two sensors per step). Meanwhile, using the decomposed context values 406 as illustrated in FIG. 4, the same information can be stored in 40 documents (10 item documents 412 for the wafers, 10 process documents 410 for the steps, and 2 source documents 408 for each step to identify each of the sensors).

FIG. 5 illustrates a non-limiting example embodiment of a decomposed fab process record for a trace, according to various aspects of the present disclosure. The trace decomposed fab process record 502 is illustrated in a JSON format, though those of skill in the art will recognize that other structured (such as XML) or unstructured formats may also be used. The illustrated trace decomposed fab process record 502 stores the same information as the trace fab process record 304 as illustrated in FIG. 3B, but as discussed above with respect to FIG. 4, the context values 406 have been decomposed into source, process, and item categories. This allows each of the decomposed categories to be stored in separate documents.

Though the categories of context values 406 are illustrated as JSON objects in the trace decomposed fab process record 502, it should be noted that this is only for illustrative purposes. In some embodiments, the trace decomposed fab process record 502 may include references to the source document 408, process document 410, and item document 412 instead of objects with the actual values.

The increased likelihood of duplication introduced by the use of decomposed context values 406 provides an opportunity to both reduce storage space consumed and to increase search performance by using document interning. Many programming languages support string interning, where duplicate string values are automatically stored in memory as a shared immutable string. This not only helps save memory by eliminating the need to store multiple copies of the same string, but also provides performance benefits for operations like equality tests, since the pointers to the shared immutable strings may be compared in a single operation instead of performing a character-by-character string comparison of the actual string values.

In some embodiments of the present disclosure, this concept of interning is applied to documents. Instead of representing the source document 408, process document 410, and item document 412 as mutable files, they may be represented as immutable documents, and the decomposed fab process record 402 may include a reference to the associated immutable document instead of including the information itself or a reference to a mutable document. By interning the source document 408, process document 410, and item document 412, some of the benefits of normalized databases can be obtained without requiring a rigid schema, since new interned documents could be added to respond to changes in configurations. Storage space is conserved, and the interned documents can be searched quickly because there are relatively few of them.

In some embodiments, the interning of documents may go a step further by interning combinations of documents as well. For example, the number of unique source documents 408 and unique process documents 410 may be relatively small. As a result, additional efficiencies may be obtained by pre-computing all unique combinations of source documents 408 and process documents 410 (along with, potentially, other metadata from the decomposed fab process record 402 such as “name” and “type” values), and storing interned versions of the combinations. This can help accelerate queries for combinations of these values even further. In some embodiments, the interned combinations may be limited to valid combinations. For example, a given process step may only be monitored by a specific set of sensors 106, and so the combinations of the process document 410 with the source documents 408 for the specific set of sensors 106 may be pre-computed without pre-computing combinations of the process document 410 with other, irrelevant source documents 408.

One will also note that, by the use of interned source documents 408, process documents 410, and item documents 412, queries based on these values may be executed extremely efficiently. For example, if a process engineer wished to retrieve all of the traces for a given wafer, a query using the interned item document 412 that identifies the wafer and lot may be used. As another example, if a process engineer wanted to retrieve all traces for a given source or a given process step, queries can be quickly executed using the associated interned source document 408 or process document 410, respectively.

FIG. 6 is a block diagram that illustrates aspects of a non-limiting example embodiment of a fab record management computing system according to various aspects of the present disclosure. The illustrated fab record management computing system 102 may be implemented by any computing device or collection of computing devices, including but not limited to a desktop computing device, a laptop computing device, a mobile computing device, a server computing device, a computing device of a cloud computing system, and/or combinations thereof. The fab record management computing system 102 is configured to decompose incoming data records from a semiconductor fabrication plant 104, and to store the decomposed records in a way that increases efficiency of storage usage while also increasing the speed of queries for information.

As shown, the fab record management computing system 102 includes one or more processors 602, one or more communication interfaces 604, a record data store 608, a trace data store 616, an interned data store 618, and a computer-readable medium 606.

In some embodiments, the processors 602 may include any suitable type of general-purpose computer processor. In some embodiments, the processors 602 may include one or more special-purpose computer processors or AI accelerators optimized for specific computing tasks, including but not limited to graphical processing units (GPUs), vision processing units (VPUs), and tensor processing units (TPUs).

In some embodiments, the communication interfaces 604 include one or more hardware and or software interfaces suitable for providing communication links between components. The communication interfaces 604 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As shown, the computer-readable medium 606 has stored thereon logic that, in response to execution by the one or more processors 602, cause the fab record management computing system 102 to provide a data collection engine 610, a record decomposition engine 612, and a record compression engine 614.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

In some embodiments, the data collection engine 610 is configured to receive the data from sensors 106 of one or more semiconductor fabrication plants 104. In some embodiments, the record decomposition engine 612 is configured to decompose incoming data records into decomposed fab process records 402, and to store the decomposed fab process records 402 in the record data store 608. In some embodiments, the record decomposition engine 612 may also be configured to convert source documents 408, process documents 410, and item documents 412 into interned documents, and to store the interned documents in the interned data store 618. In some embodiments, the record compression engine 614 is configured to compress trace information received in incoming data records and to store the compressed information in the trace data store 616. Further description of the configuration of each of these components is provided below.

As used herein, “engine” refers to logic embodied in hardware or software instructions, which can be written in one or more programming languages, including but not limited to C, C++, C #, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

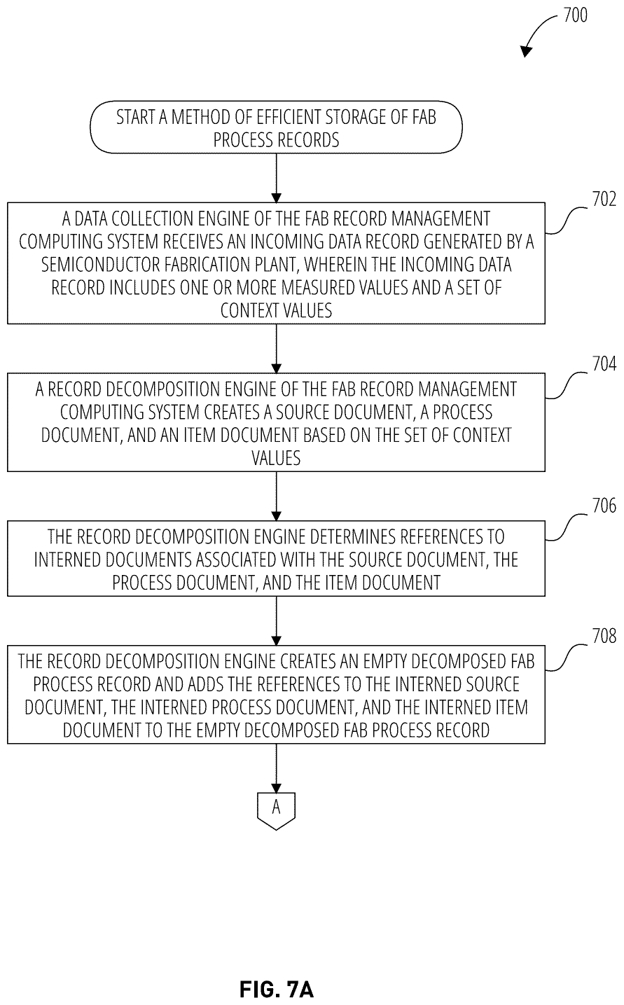

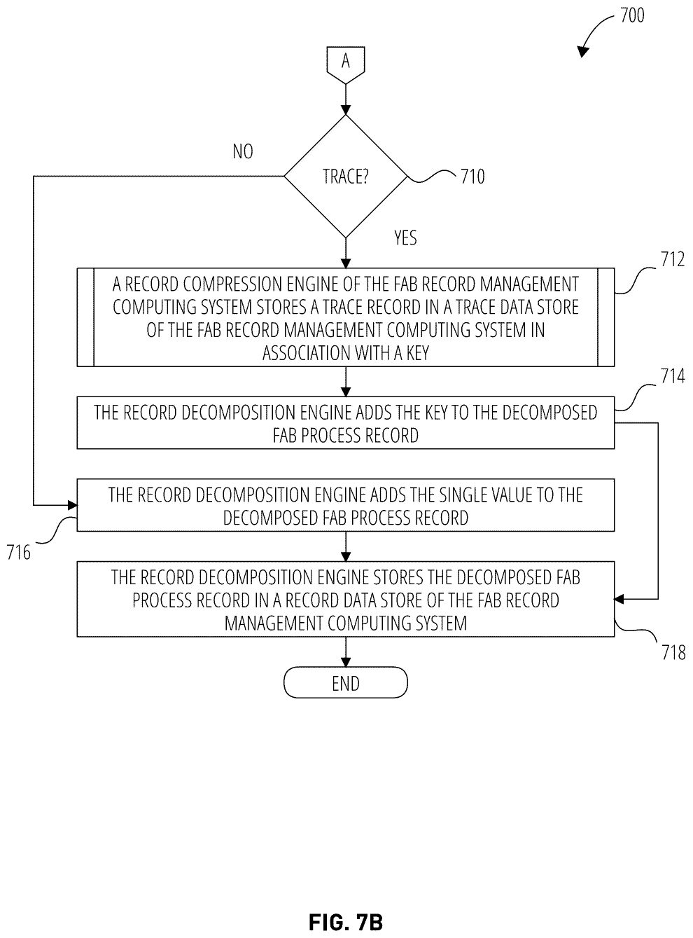

FIG. 7A-FIG. 7B are flowchart that illustrates a non-limiting example embodiment of a method of efficient storage of fab process records according to various aspects of the present disclosure. In the method 700, an incoming data record is received from a semiconductor fabrication plant 104 and is converted into a decomposed fab process record 402 for storage. Trace values, if any, within the incoming data record are also efficiently compressed in order to reduce the amount of storage used.

From a start block, the method 700 proceeds to block 702, where a data collection engine 610 of the fab record management computing system 102 receives an incoming data record generated by a semiconductor fabrication plant 104, wherein the incoming data record includes one or more measured values 404 and a set of context values 206.

At block 704, a record decomposition engine 612 of the fab record management computing system 102 creates a source document 408, a process document 410, and an item document 412 based on the set of context values 406. In some embodiments, the record decomposition engine 612 may be configured with a list of value names associated with each category of context values 406, and may add the values from the context values 406 to the appropriate document based on the list.

At block 706, the record decomposition engine 612 determines references to interned documents associated with the source document 408, the process document 410, and the item document 412. In some embodiments, the record decomposition engine 612 may compute a unique hash for each document, and may use the unique hash as a key into the interned data store 618 to determine whether an interned document has already been created to represent the information stored in each document. If an interned document associated with the unique hash is found in the interned data store 618, then the unique hash may be used as the reference to the existing interned document. Otherwise, the record decomposition engine 612 may create an interned version of the document, store the interned version of the document in the interned data store 618 in association with the unique hash, and then use the unique hash as the reference to the new interned document.

At block 708, the record decomposition engine 612 creates an empty decomposed fab process record 402 and adds the references to the interned source document 408, the interned process document 410, and the interned item document 412 to the empty decomposed fab process record 402.

The method 700 then proceeds to a continuation terminal (“terminal A”). From terminal A (FIG. 7B), the method 700 proceeds to a decision block 710, where a determination is made regarding whether the log includes trace values or a single value. In some embodiments, the one or more measured values 204 may include trace information or a single measured value (e.g., a value measured by a metrology process). Since a single value does not pose significant challenges with regard to the size of the data stored, the method 700 treats single values and trace values differently. That said, one benefit of the conceptual division between context values 406 and measured values 404 is that this separation allows for stronger compression to be applied to trace values, and so the decision block 710 allows this stronger compression to be applied to trace values without increasing the complexity of storage of single values.

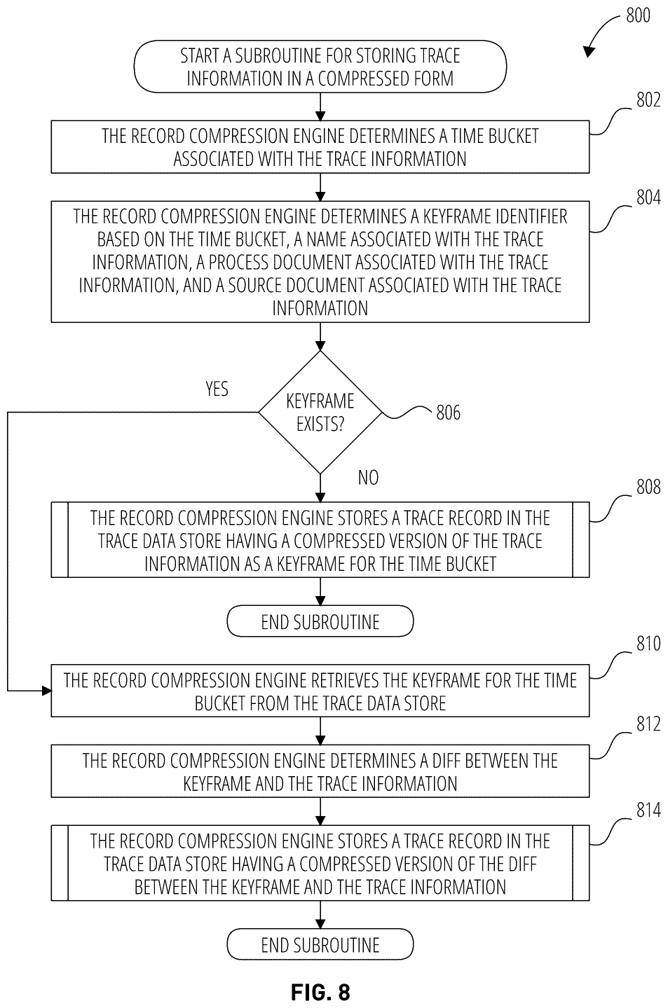

If it is determined that the log includes trace values, then the result of decision block 710 is YES, and the method 700 proceeds to subroutine block 712, where a subroutine is performed in which a record compression engine 614 of the fab record management computing system 102 stores a trace record in a trace data store 616 of the fab record management computing system 102 in association with a key. In some embodiments, the key is generated by the subroutine, and is returned to the method 700 once the trace record is stored in the trace data store 616. The subroutine executed at subroutine block 712 applies additional compression to the trace values in order to further reduce the amount of storage space consumed by the method 700. Any suitable subroutine may be used at subroutine block 712, including but not limited to the subroutine 800 illustrated in FIG. 8 and described in further detail below.

At block 714, the record decomposition engine 612 adds the key to the decomposed fab process record 402. The method 700 then proceeds to block 718.

Returning to decision block 710, if it is determined that the log does not include trace values, then the result of decision block 710 is NO, and the method 700 proceeds to block 716. At block 716, the record decomposition engine 612 stores the single value in the decomposed fab process record 402. The method 700 then proceeds to block 718.

At block 718, the record decomposition engine 612 stores the decomposed fab process record 402 in a record data store 608 of the fab record management computing system 102. The method 700 then proceeds to an end block and terminates.

FIG. 8 is a flowchart that illustrates a non-limiting example embodiment of a subroutine for storing a trace record in a compressed form according to various aspects of the present disclosure. The subroutine 800 is a non-limiting example of a suitable subroutine for use at subroutine block 712 of the method 700 discussed above. The subroutine 800 leverages characteristics of trace values generated by semiconductor fabrication plants 104 to achieve a high level of compression of the trace values. Specifically, the subroutine 800 utilizes a combination of two techniques—bitpacking and keyframe diffs—to achieve a higher amount of compression of traces than would be achieved using traditional compression techniques.

Traces generated by a semiconductor fabrication plant 104 have a particular characteristic, in that groups of traces can be identified that should have very similar values. A step for a given recipe should not vary significantly from run-to-run, assuming that the process is operating in a controlled manner, and so the corresponding traces from multiple runs should be very similar to each other. This provides an opportunity for highly efficient compression, in that instead of storing every trace, differences (“diffs”) between a new trace and a keyframe trace may be stored instead of the entire trace. Additional compression techniques, such as bitpacking and run-length encoding, may then also be applied to the trace data to provide even further savings in storage space.

It should be noted that the technical benefit of being able to group highly similar traces to be stored as diffs is provided at least in part by the decomposition of the incoming data record into a decomposed fab process record 402, and specifically, by dividing the context values 406 into process, source, and item categories. For example, the values of the process document 410 and the source document 408, taken together without the values of the item document 412, may uniquely identify a combination of a recipe, step, tool, module, station, and sensor 106 for any run. As such, if these values match between two traces, they indicate that the traces should be highly similar, because they represent corresponding traces for different runs. It should also be noted that the context values 406 for a trace will be different between different semiconductor fabrication plants 104. A more traditional data model (relational or document-oriented) would require customized code for identifying traces that can be combined. In contrast, the techniques disclosed herein may automatically find traces to be grouped together regardless of the specific content of the process document 410 and the source document 408, thus providing additional flexibility without custom logic.

Processes may drift over time, and so it should be expected that traces that should otherwise be similar may also drift over time. The more difference between trace information and the keyframe to which it is compared, the greater the amount of information present in the diff, and therefore the lower the amount of compression. It is also possible that an initial trace from which diffs are calculated may not be particularly representative of other traces in the group, and compression results may not be ideal in the long term. Therefore, the subroutine 800 organizes otherwise similar traces into time buckets, and chooses a keyframe trace for each time bucket from which diffs will be calculated for the rest of the time bucket. This helps minimize the effect of process drift and reduce the risk of choosing a non-representative keyframe, at the minor cost of having to store an entire trace as a keyframe for each time bucket.

Accordingly, from a start block, the subroutine 800 proceeds to block 802, where the record compression engine 614 determines a time bucket associated with the trace information. The time bucket may be determined by taking the floor of a timestamp associated with the trace information (e.g., a timestamp of a first entry in the trace; a timestamp metadata value of the incoming data record, or any other suitably consistent timestamp) divided by a time bucket size (e.g., a day, a week, a month, or any other suitable time bucket size).

At block 804, the record compression engine 614 determines a keyframe identifier based on the time bucket, a name associated with the trace record, a process document 410 associated with the trace record, and a source document 408 associated with the trace record. In some embodiments, the record compression engine 614 may compute a hash value based on the time bucket, the name associated with the trace record, the process document 410 of the decomposed fab process record 402, and the source document 408 of the decomposed fab process record 402. Since the process document 410 and source document 408 are interned, the record compression engine 614 may merely use the identifiers of the interned versions of the process document 410 and source document 408, as opposed to the entire documents, in the computation of the hash value. The hash value may then be used as the keyframe identifier.

The subroutine 800 then proceeds to a decision block 806, where a determination is made based on whether a keyframe identified by the keyframe identifier is present in the trace data store 616. In some embodiments, the keyframe identifier may be used as an index into a trace data store 616, which will return the keyframe associated with the keyframe identifier if one is stored in the trace data store 616, and otherwise will return no results.

If the keyframe is not present, then the result of the determination at decision block 806 is NO, and the subroutine 800 proceeds to subroutine block 808. At subroutine block 808, a subroutine is executed wherein the record compression engine 614 stores a trace record in the trace data store 616 having a compressed version of the trace as a keyframe for the time bucket. The subroutine 800 then proceeds to an end block and terminates.

Returning to decision block 806, if the keyframe is present, then the result of the determination at decision block 806 is YES, and the subroutine 800 proceeds to block 810, where the record compression engine 614 retrieves the keyframe for the time bucket from the trace data store 616. At block 812, the record compression engine 614 determines a diff between the keyframe and the trace. In some embodiments, if the keyframe is stored in the trace data store 616 in a compressed format, the keyframe may be decompressed prior to the determination of the diff. Any suitable technique may be used to determine the diff between the keyframe and the trace. In some embodiments, a simple XOR may be performed to compare the keyframe and the trace, such that only bits that are different between the keyframe and the trace will be present in the diff. Given such a diff, the original trace can be reconstituted using the keyframe and the diff, if the original trace is desired in response to a query. In some embodiments, other techniques may be used to compare the keyframe and the trace to generate the diff. At subroutine block 814, a subroutine is executed wherein the record compression engine 614 stores a trace record in the trace data store 616 having a compressed version of the diff between the keyframe and the trace.

Any suitable subroutine may be used at subroutine block 808 and subroutine block 814 for storing trace records having compressed versions of the keyframe or the diff. Typically, the same or similar subroutines will be called at subroutine block 808 and subroutine block 814, but will operate on a keyframe or a diff, respectively. In some embodiments, the subroutine will apply bitpacking and, potentially, run-length encoding, to the keyframe or the diff in order to achieve further compression.

The subroutine 800 then proceeds to an end block and returns control to its caller.

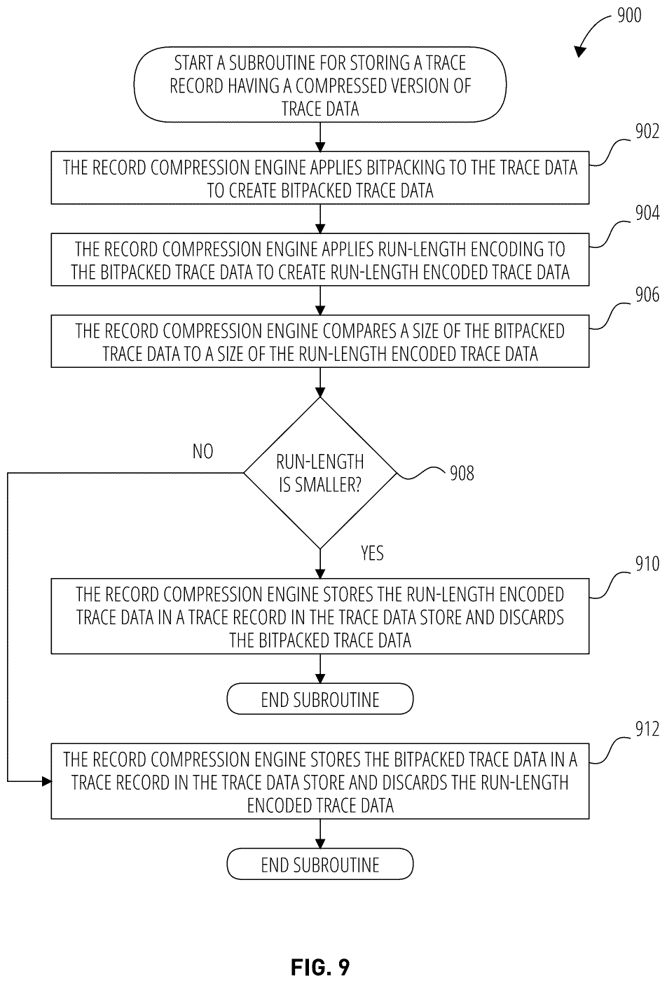

FIG. 9 is a flowchart that illustrates a non-limiting example embodiment of a subroutine for storing a trace record having a compressed version of trace data, according to various aspects of the present disclosure. The subroutine 900 is a non-limiting example of a subroutine suitable for use at subroutine block 808 and subroutine block 814 of the subroutine 800 illustrated in FIG. 8 and described in detail above. The subroutine 900 may be used on both trace data that represents a keyframe (e.g., an entire trace) or a diff (e.g., a comparison of a trace to a keyframe).

From a start block, the subroutine 900 proceeds to block 902, where the record compression engine 614 applies bitpacking to the trace data to create bitpacked trace data. Bitpacking, a type of variable-length encoding, helps avoid wasting space by assigning fewer bits to store smaller numbers when available. For example, floats in the trace data may be converted to ints (or another narrower bit width data type), and bitpacking may be applied to the resulting integer values. As another example, values that do not use the entire bit width of the data type may be stored with fewer bits, along with an indication of the number of bits used to store the value (e.g., an int value of 3 may be packed into two bits instead of the full width of an int).

At block 904, the record compression engine 614 applies run-length encoding to the bitpacked trace data to create run-length encoded trace data. In run-length encoding, a run of identical values may be replaced by a single copy of the value and an indication of how many of the values were present in the run. Trace data, including both keyframe trace data and diff trace data, may be particularly amenable to compression using run-length encoding. Keyframe trace data may frequently contain stable periods where values do not change, and so significant runs of values in the keyframe trace data may be common. Moreover, if a diff indicates few changes from the keyframe, the diff may include long runs of zeros that will be highly compressed with run-length encoding.

That said, worst-case scenarios for run-length encoding may actually increase the amount of space needed for storage. If there are few runs in the trace data, or the existing runs are short, then the overhead of adding the indications of run lengths may not outweigh the space saved by removing the runs. Accordingly, the subroutine 900 creates a run-length encoded version of the trace data, but discards it if it does not improve the compression performance. Performing this extra processing that may simply be discarded is counterintuitive. However, since the present disclosure aims to improve performance at retrieval time but is relatively unbound by computation time during ingestion, making this tradeoff helps provide the technical improvements provided by this disclosure.

Accordingly, at block 906, the record compression engine 614 compares a size of the bitpacked trace data to a size of the run-length encoded trace data. The subroutine 900 then proceeds to decision block 908, where a determination is made based on whether the run-length encoded trace data was smaller than the bitpacked trace data. If the run-length encoded trace data was smaller, then the result of decision block 908 is YES, and the subroutine 900 proceeds to block 910, where the record compression engine 614 stores the run-length encoded trace data in a trace record in the trace data store 616 and discards the bitpacked trace data. The subroutine 900 then proceeds to an end block and returns control to its caller.

Returning to decision block 908, if the run-length encoded trace data was not smaller, then the result of decision block 908 is NO, and the subroutine 900 proceeds to block 912, where the record compression engine 614 stores the bitpacked trace data in a trace record in the trace data store 616 and discards the run-length encoded trace data. The subroutine 900 then proceeds to an end block and returns control to its caller.

On real data samples, the above techniques have shown strong compression performance compared to a naïve approach that stored standard 8-byte arrays for timestamps and values. On these real data samples, a 13× compression factor was achieved compared to a column-oriented approach for storing the trace information. Along with this improved compression size, because the trace information is compressed individually, the compressed data is also retrievable and extractable via random access, thus providing an improvement of functionality compared to previous techniques that compress larger chunks of data together.

While illustrative embodiments have been illustrated and described, it will be appreciated that various changes can be made therein without departing from the spirit and scope of the invention.

The embodiments of the invention in which an exclusive property or privilege is claimed are defined as follows:

1. A computer-implemented method for managing semiconductor manufacturing data, the method comprising:
receiving, by a computing system, an incoming data record generated by a semiconductor fabrication plant, wherein the incoming data record includes at least one measured value and a set of context values;
determining, by the computing system, one or more context documents that represent the set of context values of the incoming data record; and
storing, by the computing system in a data store, a decomposed fab process record that includes a representation of the at least one measured value and the one or more context documents.

2. The computer-implemented method of claim 1, wherein the one or more context documents include a source document, a process document, and an item document;
wherein the source document identifies a physical sensor used to generate the at least one measured value;
wherein the process document identifies a recipe step associated with the at least one measured value; and
wherein the item document identifies a physical item being processed.

3. The computer-implemented method of claim 2, further comprising:
pre-computing, by the computing system, unique combinations of process documents and source documents; and
storing, by the computing system, the unique combinations of process documents and source documents in an interned data store to accelerate queries based on combinations of process documents and source documents.

4. The computer-implemented method of claim 1, wherein each context document is an immutable interned document.

5. The computer-implemented method of claim 1, wherein the at least one measured value includes trace information; and
wherein storing the decomposed fab process record that includes the representation of the at least one measured value and the one or more context documents includes storing a trace record in a trace data store, wherein the trace record includes trace data that represents the trace information.

6. The computer-implemented method of claim 5, wherein storing the trace record in the trace data store includes:
determining a trace group associated with the incoming data record;
determining whether a keyframe is present in the trace data store for the trace group;
in response to determining that the keyframe is present in the trace data store, using a difference between the trace information and the keyframe as the trace data; and
in response to determining that the keyframe is not present, using the trace information as the trace data.

7. The computer-implemented method of claim 6, wherein determining the trace group associated with the incoming data record includes:
determining a keyframe identifier hash based on a source document of the context documents, a process document of the context documents, a name in the incoming data record, and a time bucket; and
determining the trace group based on the hash.

8. The computer-implemented method of claim 5, wherein storing the trace record in the trace data store includes:
creating bitpacked trace data by applying bitpacking to the trace data.

9. The computer-implemented method of claim 8, wherein storing the trace record in the trace data store includes:
creating run-length encoded trace data by using run-length encoding to encode the bitpacked trace data; and
storing a smaller of the run-length encoded trace data and the bitpacked trace data in the trace data store.

10. The computer-implemented method of claim 1, further comprising:
receiving a query for trace information associated with a combination of context values;
determining context documents that match the combination of context values; and
retrieving decomposed fab process records associated with the context documents.

11. A non-transitory computer-readable medium having computer-executable instructions stored thereon that, in response to execution by one or more processors of a computing system, cause the computing system to perform actions for managing semiconductor manufacturing data, the actions comprising:
receiving, by the computing system, an incoming data record generated by a semiconductor fabrication plant, wherein the incoming data record includes at least one measured value and a set of context values;
determining, by the computing system, one or more context documents that represent the set of context values of the incoming data record; and
storing, by the computing system in a data store, a decomposed fab process record that includes a representation of the at least one measured value and the one or more context documents.

12. The non-transitory computer-readable medium of claim 11, wherein the one or more context documents include a source document, a process document, and an item document;
wherein the source document identifies a physical sensor used to generate the at least one measured value;
wherein the process document identifies a recipe step associated with the at least one measured value; and
wherein the item document identifies a physical item being processed.

13. The non-transitory computer-readable medium of claim 12, wherein the actions further comprise:
pre-computing, by the computing system, unique combinations of process documents and source documents; and
storing, by the computing system, the unique combinations of process documents and source documents in an interned data store to accelerate queries based on combinations of process documents and source documents.

14. The non-transitory computer-readable medium of claim 11, wherein each context document is an immutable interned document.

15. The non-transitory computer-readable medium of claim 11, wherein the at least one measured value includes trace information; and
wherein storing the decomposed fab process record that includes the representation of the at least one measured value and the one or more context documents includes storing a trace record in a trace data store, wherein the trace record includes trace data that represents the trace information.

16. The non-transitory computer-readable medium of claim 15, wherein storing the trace record in the trace data store includes:
determining a trace group associated with the incoming data record;
determining whether a keyframe is present in the trace data store for the trace group;
in response to determining that the keyframe is present in the trace data store, using a difference between the trace information and the keyframe as the trace data; and
in response to determining that the keyframe is not present, using the trace information as the trace data.

17. The non-transitory computer-readable medium of claim 16, wherein determining the trace group associated with the incoming data record includes:
determining a keyframe identifier hash based on a source document of the context documents, a process document of the context documents, a name in the incoming data record, and a time bucket; and
determining the trace group based on the hash.

18. The non-transitory computer-readable medium of claim 15, wherein storing the trace record in the trace data store includes:
creating bitpacked trace data by applying bitpacking to the trace data.

19. The non-transitory computer-readable medium of claim 18, wherein storing the trace record in the trace data store includes:
creating run-length encoded trace data by using run-length encoding to encode the bitpacked trace data; and
storing a smaller of the run-length encoded trace data and the bitpacked trace data in the trace data store.

20. The non-transitory computer-readable medium of claim 11, wherein the actions further comprise:
receiving a query for trace information associated with a combination of context values;
determining context documents that match the combination of context values; and
retrieving decomposed fab process records associated with the context documents.
